(19) United States
(12) Patent Application Publication
(10) Pub. No.: US 2006/0001892 A1
(43) Pub. Date: Jan. 5, 2006

(54) Image processing method and image processing device

(76) Inventor: Xuqiang Bai, Ibaraki-ken (JP)

Correspondence Address: NATH & ASSOCIATES, PLLC, Sixth Floor, 1030 15th Street, N.W., Washington, DC, 20005, US

(21) Appl. No.: 11/168,556

(22) Filed: Jun. 29, 2005

(30) Foreign Application Priority Data
Jun. 30, 2004 (JP) P2004-193170

(51) Int. Cl. G06F 15/00

(52) U.S. Cl. 358/1.9

(57) ABSTRACT

The present invention provides an image processing method and an image processing device for relative accurate color transforming as well as extremely high-speed processing. The image processing method for transforming image data of a scanner RGB color space obtained by a scanner into image data of a printer CMYK color space of a color printer, the image processing method including preparing a color transform look-up table in accordance with an Input ICC profile of the scanner and Output ICC profile of the color printer, and transforming the image data of the scanner RGB color space of the scanner into the image data of the CMYK color space of the color printer by referring to the color transform look-up table. According to the method, the amount of time for the image processing is decreased and the storage volume for storing the color transform look-up table is reduced.

### CROSS REFERENCE TO RELATED APPLICATIONS AND INCORPORATION BY REFERENCE

This application is based upon and claims the benefit of priority from prior Japanese Patent Application P2004-193170 filed on Jun. 30, 2004; the entire contents of which are incorporated by reference herein.

### BACKGROUND OF THE INVENTION

1. Field of the Invention

The present invention relates to a technique performing a color matching simply and accurately for devices inputting and outputting image data.

2. Description of the Related Art

A personal computer (PC) functions to retrieve color image data captured by a digital camera or a scanner and to transmit the color image data to a color printer.

In such an image processing, because each device inputting and outputting the image data has a respective gamut (color gamut), it is require to ensure consistency of the image data among the devices when the image data is processed among the devices. The International Color Consortium (ICC) profile is well known as a profile format.

The ICC profile includes a transform table, which is used for transforming a device dependent color space of the device into a device independent color space, or which is used for transforming a device independent color space into a device dependent color space. For instance, in the case where the transform table includes the device dependent color space consisting of CMYK (Cyan Magenta Yellow blacK) color space and the device independent color space consisting of CIE-Lab color space, a CIE-L*a*b value corresponding to each of plurality of values in the CMYK color space is stored in the transform table.

Therefore, according to the ICC profile, for instance, image data scanned by a scanner in the device dependent color space is transformed into image data in the device independent color space and then the image data transformed in the device independent color space is transformed into image data in another device dependent color space of a color printer, in order to print a color picture, which is scanned by the scanner, with exact color reproduction. For example, Japan Patent Laid Open No. 2003-289448 discloses the technique.

The technique is set forth below with reference to FIG. 1. RGB image data scanned by a scanner 101 is transformed into image data of the device independent color space 102 in according with an Input ICC profile. Then, the image data transformed in the device independent color space is further transformed into the printer CMYK image data in accordance with an Output ICC profile for output by the printer 103.

However, the technique of image processing is disadvantageous in that a large amount of processing time is needed for color transformation since two color transform processes are required. The two color transform processes consist of the first process conducted between color space of the scanner 101 and the device independent color space 102 and the second process conducted between the device independent color space 102 and color space of the color printer 103.

One disadvantage of the image processing method is the large amount of time for the two color transform processes. Another is the huge amount of work that is required for complicated operation of commercially available tools to create and compile the ICC profile.

Furthermore, high-speed processing is needed in the color transform process by an application provided in a printer driver or a printer controller. But, low-speed processing of the color transform process using the ICC profile adversely makes it difficult to realize the high-speed processing time of the printer driver and the printer controller.

### SUMMARY OF THE INVENTION

The present invention is proposed for resolving the above-described drawbacks, and provides an image processing method and an image processing device which are available for relative accurate color transforming as well as high-speed color transforming.

A first aspect of the present invention inheres in an image processing method for transforming image data in a device dependent color space of a first device into image data in a device dependent color space of a second device. The image processing method including: generating a color transform look-up table configured to transform the image data in the device dependent color space of the first device into the image data in the device dependent color space of the second device in accordance with an ICC profile of the first device and the second device; transforming the image data retrieved from the first device into the image data in the device dependent color space of the second device by referring to the color transform look-up table.

A second aspect of the present invention inheres in an image processing method for transforming image data in a device independent color space into image data in a device dependent color space of a given device. The image processing method including: generating a color transform look-up table configured to transform the image data in the device independent color space into the image data in the device dependent color space of the given device in accordance with an ICC profile of the given device; transforming the image data in the device independent color space into the image data in the device dependent color space of the given device by referring to the color transform look-up table.

A third aspect of the present invention inheres in an image processing method for transforming image data in a device dependent color space of a given device into image data in a device independent color space. The image processing method comprising: generating a color transform look-up table configured to transform the image data in the device dependent color space of the given device into the image data in the device independent color space in accordance with an ICC profile of the given device; transforming the image data retrieved from the given device into the image data in the device independent color space by referring to the color transform look-up table.

A fourth aspect of the present invention inheres in an image processing method, in which the device dependent color space includes at least one of a RGB color space, a CMYK color space, an HSV color space, an HSB color space, and an HLS color space.

A fifth aspect of the present invention inheres in the image processing method, in which the device independent color space includes at least one of a CIE-XYZ color space, a CIE-Lab color space, and an sRGB color space.

A sixth aspect of the present invention inheres in the image processing method including: preparing a plurality of types of rendering intent that may be selected. The color transform look-up table is generated in accordance with the type of rendering intent.

A seventh aspect of the present invention inheres in the image processing method that includes changing the data size of the color transform look-up table by changing the number of lattice points in color space associated with the color transform look-up table.

An eighth aspect of the present invention inheres in an image processing device for transforming image data in a device dependent color space of a first device into image data in a device dependent color space of a second device. The image processing device includes a storage unit configured to store ICC profiles of the first device and the second device; and a color transform look-up table generator configured to generate a color transform look-up table transforming the image data in the device dependent color space of the first device into the image data in the device dependent color space of the second device in accordance with the ICC profiles of the first device and the second device; a color transform look-up table storage unit configured to the color transform look-up table, which is used in the case that a process of transforming the image data in the device dependent color space of the first device into image data in the device dependent color space of the second device, is performed.

A ninth aspect of the present invention inheres in an image processing device for transforming image data in a device independent color space into image data in a device dependent color space of a given device. The image processing device includes a storage unit configured to store ICC profiles of the given device; a color transform look-up table generator configured to generate a color transform look-up table transforming the image data in the device independent color space into the image data in the device dependent color space of the given device in accordance with the ICC profiles of the given device; and a color transform look-up table storage unit configured to the color transform look-up table, which is used in the case that a process of transforming the image data in the device independent color space into the image data in the device dependent color space of the given device, is performed.

A tenth aspect of the present invention inheres in an image processing device for transforming image data in a device dependent color space of a given device into image data in a device independent color space. The image processing device comprises a storage unit configured to store ICC profiles of the given device; a color transform look-up table generator configured to generate a color transform look-up table transforming the image data in the device dependent color space of the given device into the image data in the device independent color space in accordance with the ICC profiles of the given device; and a color transform look-up table storage unit configured to the color transform look-up table, which is used in the case that a process of transforming the image data in the device dependent color space of the given device into the image data in the device independent color space, is performed.

According to the first aspect and the eighth aspect, the color transform look-up table is generated in accordance with the ICC profile of the first device and the second device. The color transform look-up table is used for transforming the image data in the device dependent color space of the first device into the image data in the device dependent color space of the second device. The image data is transmitted to the second device after the image data is transformed from the image data of the device dependent color space which is obtained by the first device to the image data of the device dependent color space of the second device. Therefore, relative accurate color transforming and high-speed processing are achieved.

According to the second aspect and the ninth aspect, the color transform look-up table is generated in accordance with the ICC profile of any device. The color transform look-up table is used for transforming the image data in the device independent color space into the image data in the device dependent color space of such device. Therefore, relative accurate color transforming and high-speed processing are achieved.

According to the third aspect and the tenth aspect, the color transform look-up table is generated in accordance with the ICC profile of any device. The color transform look-up table is used for transforming the image data in the device dependent color space into the image data in the device independent color space of such device. Therefore, relative accurate color transforming and high-speed processing are achieved.

According to the fourth aspect, at least one of the RGB color space, the CMYK color space, the HSV color space, the HSB color space, and the HLS color space may be used as the device dependent color space. Therefore, relative accurate color transforming is achieved for generic devices which have different types of device dependent color space.

According to the fifth aspect, at least one of the CIE-XYZ color space, the CIE-Lab color space, and the sRGB color space may be used as the device independent color space. Therefore, relative accurate color transforming is achieved for generic devices which have different types of device independent color space.

According to the sixth aspect, when the color transform look-up table is generated, the type of rendering intents is set. Therefore, the color transform look-up table, which creates colors desired by the user, is generated.

According to the seventh aspect, when the color transform look-up table is generated, the lattice points are set arbitrarily. Therefore, image data with high accuracy of color reproduction is achieved.

### BRIEF DESCRIPTION OF THE DRAWINGS

FIG. 1 is a diagram schematically showing the related art.

FIG. 2 is a block diagram showing the configuration of the image processing device according to the embodiment of the present invention.

FIG. 3 is a flowchart showing the procedure for process (first process) of the image processing device according to the first embodiment, in which the color transform look-up table is generated.

FIG. 4 is a flowchart showing the procedure for the process (second process) in which the image data is transformed using the color transform look-up table according to the first embodiment.

FIG. 5 is a diagram schematically showing the color transform look-up table according to the first embodiment.

FIG. 6 is a diagram schematically showing the procedure for process of the image processing device according to the first embodiment.

FIG. 7 is a flowchart showing the procedure for process (first process) of the image processing device according to the second embodiment, in which the color transform look-up table is generated.

FIG. 8 is a diagram schematically showing the procedure for process of the image processing device according to the second embodiment.

FIG. 9 is a flowchart showing the procedure for the process (second process) in which the image data is transformed using the color transform look-up table according to the second embodiment.

FIG. 10 is a flowchart showing the procedure for process (first process) of the image processing device according to the third embodiment, in which the color transform look-up table is generated.

FIG. 11 is a flowchart showing the procedure for the process (second process) in which the image data is transformed using the color transform look-up table according to the third embodiment.

FIG. 12 is a diagram schematically showing the procedure of the image processing device according to the third embodiment.

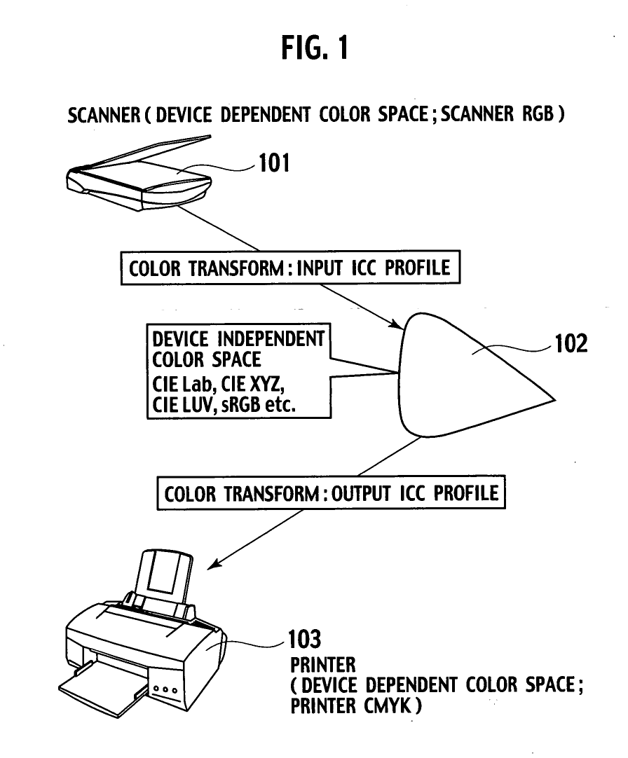

### DETAILED DESCRIPTION OF THE INVENTION

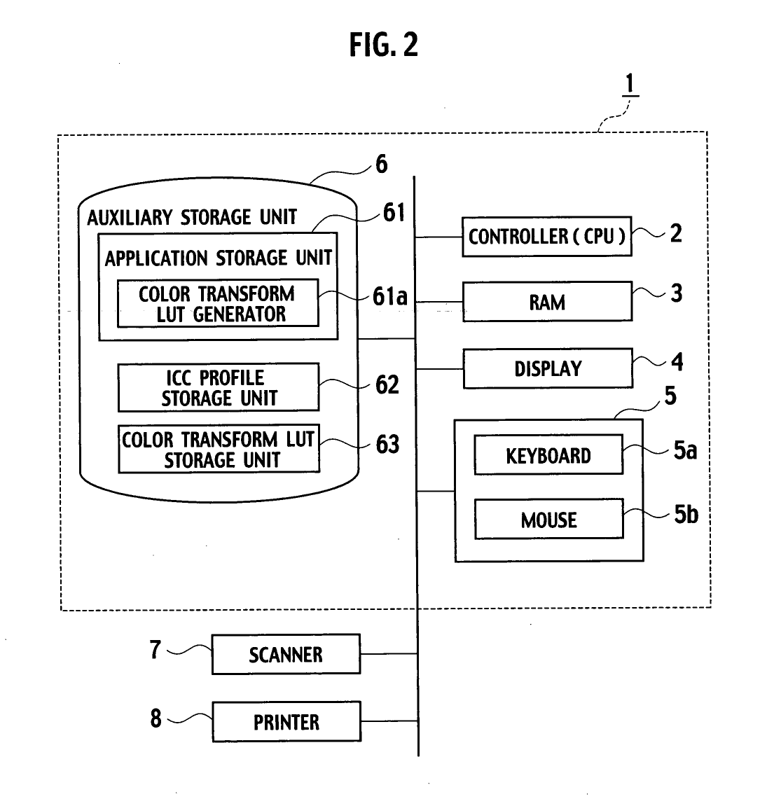

The embodiment of the present invention is described below with reference to the figures. FIG. 2 is a block diagram schematically showing a configuration of an image processing device of the present invention. As shown in FIG. 2, the image processing device 1 includes a controller 2 for controlling the overall components, a random access memory (RAM) 3, a display 4, an input device 5 including a keyboard 5a and a mouse 5b, and an auxiliary storage unit 6.

Further, the image processing device 1 includes a scanner (a first device) 7 for retrieving or obtaining color image data, and a color printer (a second device) 8 for printing out the image data.

The auxiliary storage unit 6 includes an application storage unit 61 for storing an application, an ICC profile storage unit 62 for storing an ICC profile, and a color transform LUT (look-up table) storage unit 63 for storing a color transform look-up table.

The ICC profile storage unit 62 is capable of storing a transform table to transform the image data in a device dependent color space into the image data in a device independent color space and vice versa. That is, to also transform the image data in the device independent color space into the image data in the device dependent color space. In the embodiment, the ICC profile storage unit 62 stores an Input ICC profile of the scanner 7, and an Output ICC profile of the color printer 8.

The application storage unit 61 is capable of storing any type of applications, including a color transform LUT generator 61a to generate the transform table for transforming the image data in the device dependent color space of the scanner 7 into the image data in the device dependent color space of the color printer 8, based on the Input ICC profile of the scanner 7 and the Output ICC profile of the color printer 8 in the embodiment.

In the embodiment, a scanner RGB color space as the device dependent color space of the scanner 7 and a printer CMYK color space as the device dependent color space of the color printer 8 are described as examples.

The color transform LUT generator 61a is capable of setting a lattice point (point corresponding to pixel value) of the scanner RGB color space when the color transform look-up table is generated. In this application, a lattice point of color space corresponds to a pixel value in the color space. For instance, in the case where each pixel value (image data) of R (Red), G (Green), and B (Blue) has 256 (0 to 255) tones of color gamut, accuracy of the color transform look-up table is adjusted by setting the number of the lattice point for transformation with any color gamut. For example, while the color transform look-up table has (256)³ pieces of data in the case of 256 lattice points, it has (3)³=27 pieces of data in the case of 3 lattice points. Therefore, the relationship between accuracy of the color transform and pieces of data is adjusted optimally by setting the number of lattice points.

The color transform LUT generator 61a is capable of setting a rendering intent. That is, a nonexistent color is complemented based on at least one of rendering intents, such as perception, color saturation, color relativity, and absolute color. These rendering intents are provided as the rendering intents in the ICC, so as to complement or compensate for a nonexistent color occurring when the color transform is performed between different color spaces such as the scanner RGB color space and the printer CMYK color space, which do not include a corresponding color.

When perception is used as the rendering intent, for example, in a case where a color compression is executed from a large color space to a small color space, whole color compression process, the compression process relating to color saturation, brightness of color and so on, is performed. Further, when color saturation is used as the rendering intent, for example, in a case where a color compression is executed from a large color space to a small color space, color is compressed with taking count of its color saturation. Additionally, when color relativity or absolute color is used as the rendering intent, for example, in a case where a color compression is executed from a large color space to a small color space, color is compressed while common color in a color space is kept approximately before and after the compression. Meanwhile, white color does not compressed when the rendering intent is the absolute color, whereas white color is compressed when the rendering intent is the color relativity.

For instance, when as the rendering intent is the color saturation is selected, RGB color space is changed to the Lab color space, and color compression is executed related to each of pixel (L, a, b) of the Lab color space. In this color compression, the color compression operation regarding color saturation (a) is executed. The color compressed Lab color space is changed to CMYK color space. As mentioned bellow, a look-up table between RGB color space and CMYK color space is calculated. In this case, it is evident that this look-up table is generated in accordance with color saturation (type of rendering intent).

Of course, this is an example of making a look-up table, therefore, it is also possible to use a device independent color space other than Lab color space. As the method is well known in the art, the detailed method of a rendering intent is omitted in this application.

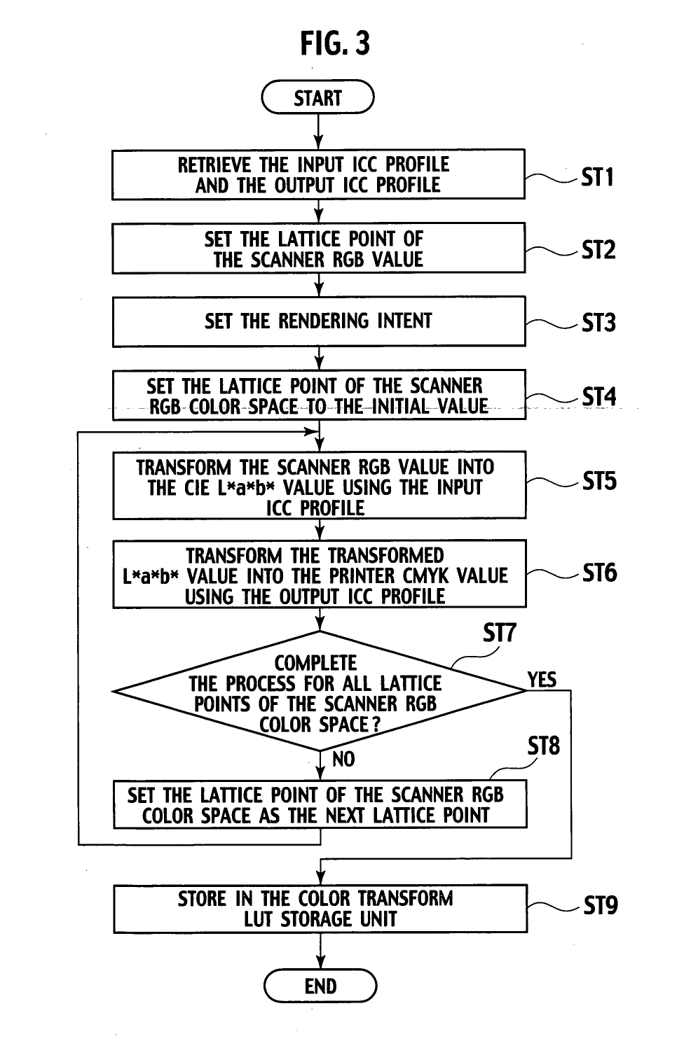

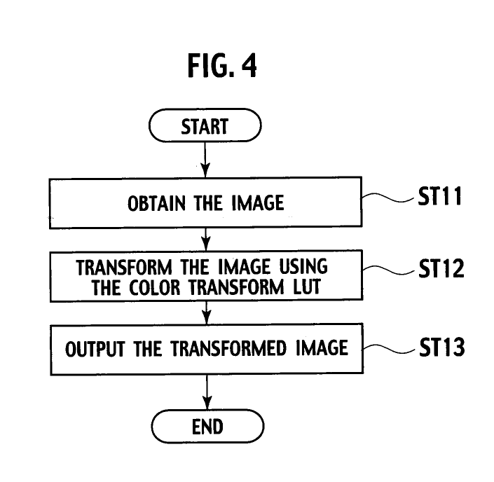

Next, operation of the image processing device of the above-described embodiment is set forth below with reference to flowcharts in FIG. 3 and FIG. 4. FIG. 3 is a flowchart showing a process (a first process) for generating the color transform look-up table by means of the color transform LUT generator 61a. FIG. 4 is a flowchart showing a process (a second process) for outputting the image data obtained by the input device to the output device using the color transform look-up table.

The color transform LUT generator 61a retrieves the Input ICC profile of the scanner 7 and the Output ICC profile of the color printer 8, which are stored in the ICC profile storage unit 62, and transmits the profiles to the RAM 3 (step ST1 in FIG. 3).

For example, the Input ICC profile is generated as follows. Each patch image of a test chart is scanned by the scanner 7. Data obtained by scanning is compared with data in the device independent color space for each path image, such as the CIE-Lab color space. Utilizing the comparison result, the Input ICC profile is generated, the profile indicating relationship between each data (pixel value) in the scanner RBG color space and data in the device independent color space. For example, the Output ICC profile is generated as follows. A sheet including image corresponding to a test chart is printed by the color printer 8. Data concerning each patch image of the test chart is measured by a color measuring unit. Utilizing data measured by a color measuring unit, the Output ICC profile is generated, the profile indicating relationship between each data (pixel value) in the printer CMYK color space and data in the device independent color space.

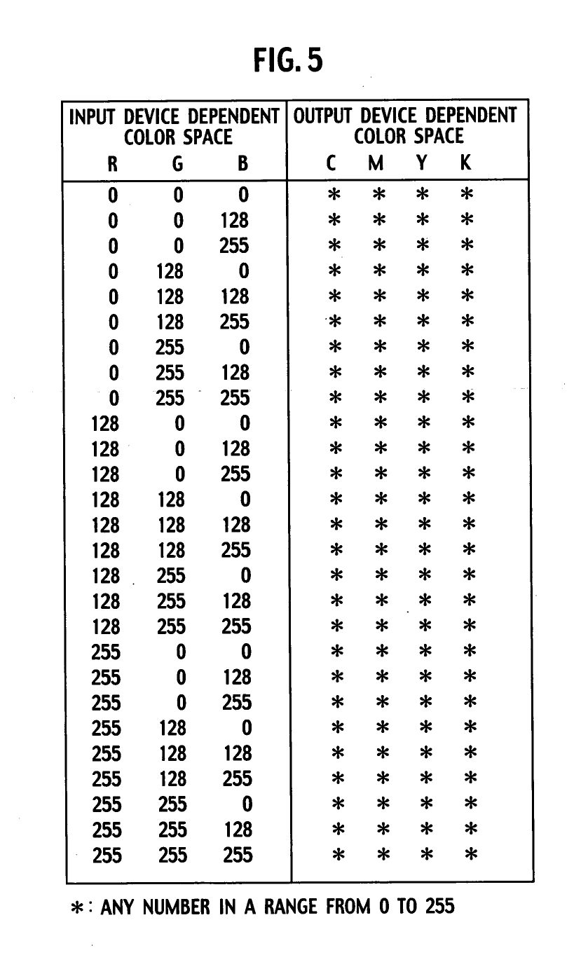

The lattice point of the scanner RGB value (pixel value) corresponding to the device dependent color space of the scanner 7 is set (step ST2). In the process, the color transform LUT generator 61a instructs the display 4 to display a screen for setting the lattice point of the color transform look-up table. Then, the desired lattice point is entered with the keyboard 5a or the mouse 5b. For instance, when the color tones (pixel values) 0, 128, and 255 are set, 27 pairs of data corresponding to the lattice points of the scanner RGB value are generated as shown in FIG. 5. It is possible for the color transform LUT generator 61a to provide a method for instructing the lattice point set to a default value to be displayed on the display 4 and allowing a user to accept the default value.

Further, the color transform LUT generator 61a provides an instruction for information of the rendering intent selection to be displayed on the display 4. The type of the rendering intent is set by being selected with the input device 5 by the user monitoring the display 4 (step ST3). It is possible for the color transform LUT generator 61a to provide a method for instructing a given type of set to a default value to be displayed on the display 4 so that the user can approve it.

The color transform LUT generator 61a provides an instruction for the lattice point in the scanner RGB color space of the scanner 7 to be set to an initial value, for example, (0, 0, 0), in step ST4, transforming the image data (each pixel value) of the scanner RGB into the image data (corresponding pixel value) in the CIE-Lab color space (device independent color space) with reference to the Input profile retrieved and transmitted to the RAM 3 in step ST5.

The color transform LUT generator 61a performs the process for transforming the image data into image data (pixel values) in the printer CMYK color space of the color printer 8 with reference to the Output profile retrieved and transmitted to the RAM 3 (step ST6). Consequently, the value in the printer CMYK color space of the color printer 8, which corresponds to the lattice point in the scanner RGB color space, for example, (0, 0, 0) shown in FIG. 5, is generated and stored in the RAM 3.

Then, the lattice point for above transforming in the scanner RGB color space is changed to the next lattice point, for example, (0, 0, 128) (NO in step ST7 and step ST8) so as to generate the value in the printer CMYK color space, which corresponds to the next lattice point, in a similar process described above. When the process for all lattice points in the scanner RGB color space are completed (YES in step ST7) a color transform look-up table is generated, as shown in FIG. 5. The generated color transform look-up table is stored in the color transform LUT storage unit 63.

As above, the color transform look-up table, which is used for transforming the image data in the scanner RGB color space of the scanner 7 into the image data in the printer CMYK color space of the color printer 8, is generated.

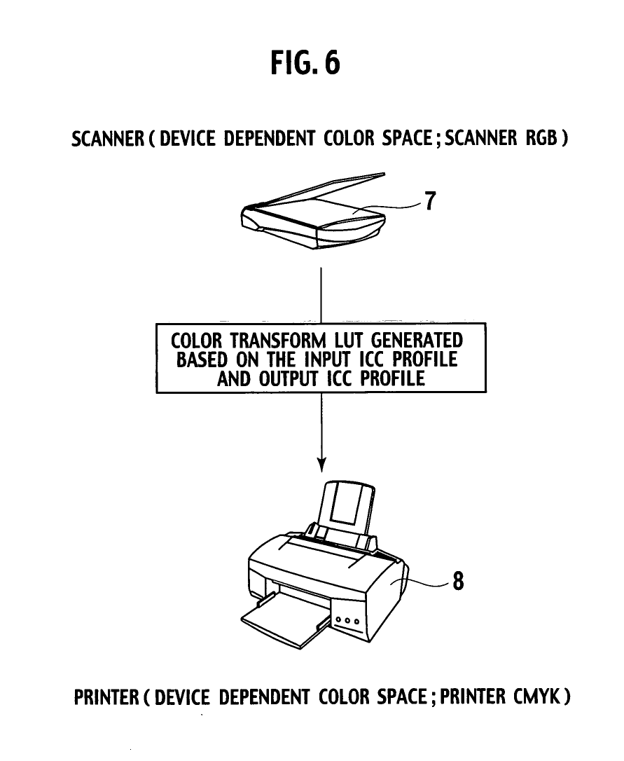

A procedure, in which the color printer 8 prints out a printed sheet concerting the color image data obtained by the scanner 7 using the color transform look-up table, is described below with reference to FIG. 4 and FIG. 6.

The color image is scanned or obtained by the scanner 7 (step ST11). Then, the image data of the scanner RGB is retrieved and transmitted to the image processing device 1. The color transform look-up table stored in the color transform LUT storage unit 63 is retrieved and transmitted to the RAM 3 so as to perform the process transforming the retrieved image data of the scanner RGB into the image data of the printer CMYK (step ST12).

As detail description is omitted, the color transform look-up table is referenced for each pixel to perform the process transforming the image data (pixel values) of the scanner RGB into the image data (pixel values) of the printer CMYK by an interpolating process. Then, the process proceeds to the next step after completing the transform process of all pixels.

The image data of the printer CMYK is then transmitted to the color printer 8 for printing it out (step ST13).

As above, the image processing device 1 according to the first embodiment of the present invention stores the color transform look-up table generated preliminarily, which is referenced for the color transformation between the scanner RGB color space of the scanner 7 and the printer CMYK color space of the color printer 8, in the color transform LUT storage unit 63. In that case the image data is inputted from the scanner 7, the image data is transformed into the image data of the printer CMYK of the color printer 8 by reference to the color transform look-up table in order to substantially decrease the amount of time for processing.

That is, while the processes, which first transform image data of the scanner RGB scanned by the scanner 7 into image data of the device independent color space, such as the CIE-Lab color space, and then transform the image data of the CIE-Lab color space into the image data of the printer CMYK of the color printer 8, were previously required, the image data of the scanner RGB is transformed into the image data of the printer CMYK directly in the present embodiment to substantially decrease the amount of time for the image processing.

Also, because the rendering intent for the color transform is set when the color transform look-up table is generated, the rendering intent favored by the user is available to be set so as to obtain the image data with the desired color.

Further, because the lattice point is set arbitrarily when the color transform look-up table is generated, the accuracy of color reproduction is set variously in accordance with the user's request. That is, in the case of less accurate color reproduction, data volume or data size of the color transform look-up table is reduced by decreasing the number of the lattice points so as to decrease the amount of time for generating the color transform look-up table and for processing the image data. Consequently, a storage capacity for the color transform look-up table is reduced.

Even in the case of highly accurate color reproduction, the amount of time for generating the color transform look-up table and the storage volume for storing the color transform look-up table increases by enlarging the number of lattice points as well as the image data with highly accurate color reproduction.

That is, the present embodiment can resolve drawbacks regarding the image processing method using the conventional ICC profile, in which the data size of the ICC profile is huge and the three types of rendering intent (perception, sustainment of color saturation, and sustainment of relative color gamut) require a huge memory.

Also, intervals of the lattice points are not set into equal value but into any value. The color space such as the RGB color space, the CIE-Lab color space, and the CMYK color space includes color (hue, saturation, and value) capable of changing nonlinearly. Therefore, by setting a large number of lattice points in the area where magnitude of the change of color is large and setting a small number of lattice points in the area where magnitude of the change of color is small, the image data, which is reproduced in color with an overall balance, contributes to improvement of picture quality.

Further, the device dependent color space is not limited to the RGB color space and the CMYK color space. The device dependent color space may include an HSV (Hue, Saturation, Value) color space, an HSB (Hue, Saturation, Brightness) color space and an HLS (Hue, Lightness, Saturation) for generation of the color transform look-up table in a manner similar to the process described above, so as to achieve the above-described effect.

The device independent color space is not limited to the CIE-Lab color space. The device independent color space may include a CIE-XYZ color space and an sRGB color space, so as to achieve the described-above effect.

A second embodiment of the present invention is set forth below.

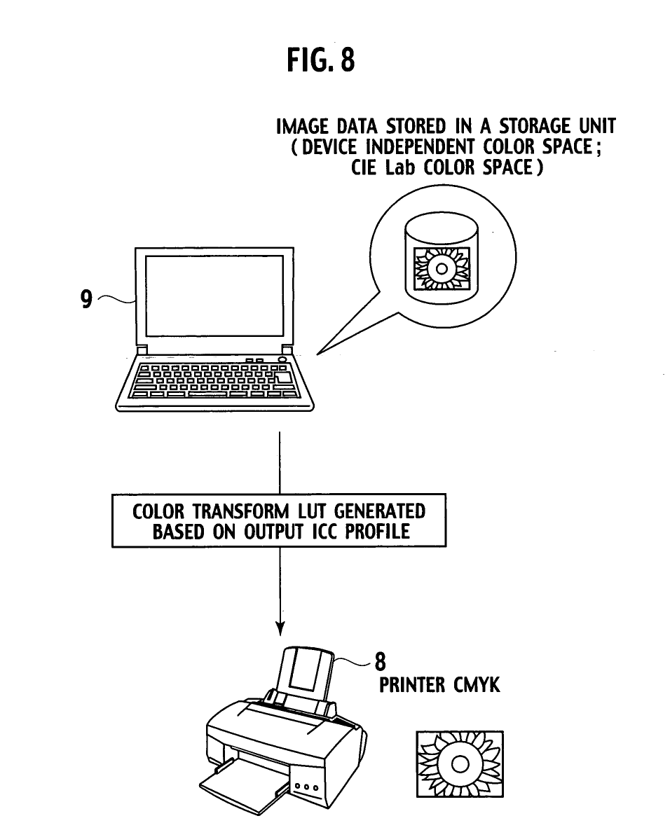

In the first embodiment shown in FIG. 6, the image data of the scanner RGB (device dependent color space) obtained by the scanner 7 is transformed into the image data of the printer CMYK (device dependent color space) to be output. In the second embodiment shown in FIG. 8, image data of the device independent color space, such as the CIE-Lab, stored in the PC 9 etc., is transformed into image data of the device dependent color space, such as the printer CMYK of the color printer 8. A configuration of the second embodiment is similar to that in FIG. 2. The above-detailed description is applicable. However, since the scanner 7 is not necessary for the second embodiment, it is adequate for the second embodiment that the ICC profile storage unit 62 stores the Output profile of the color printer 8.

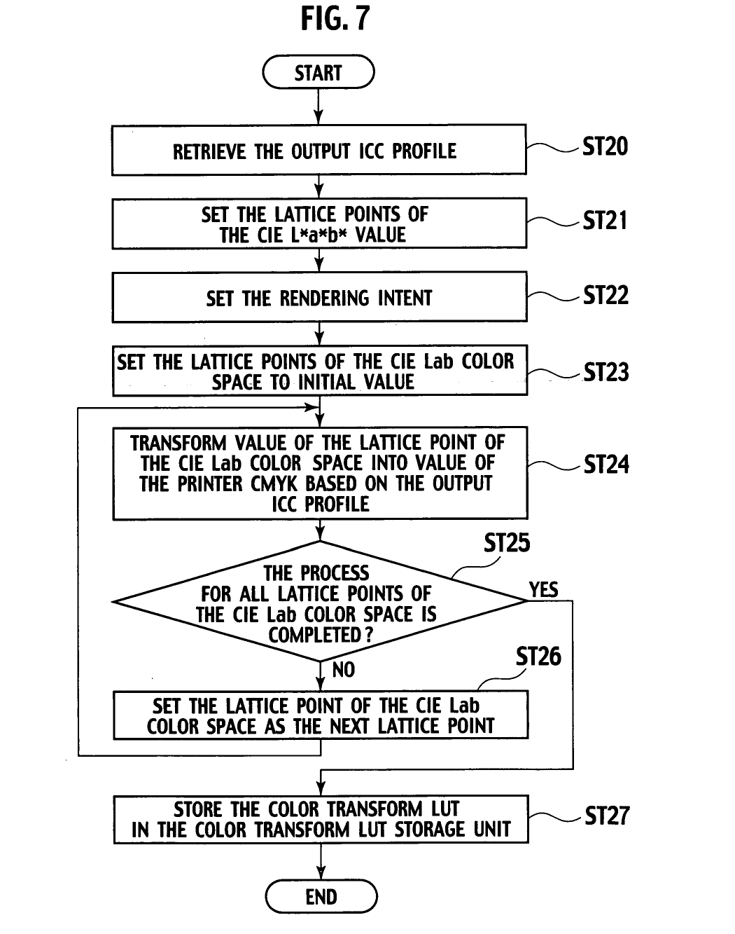

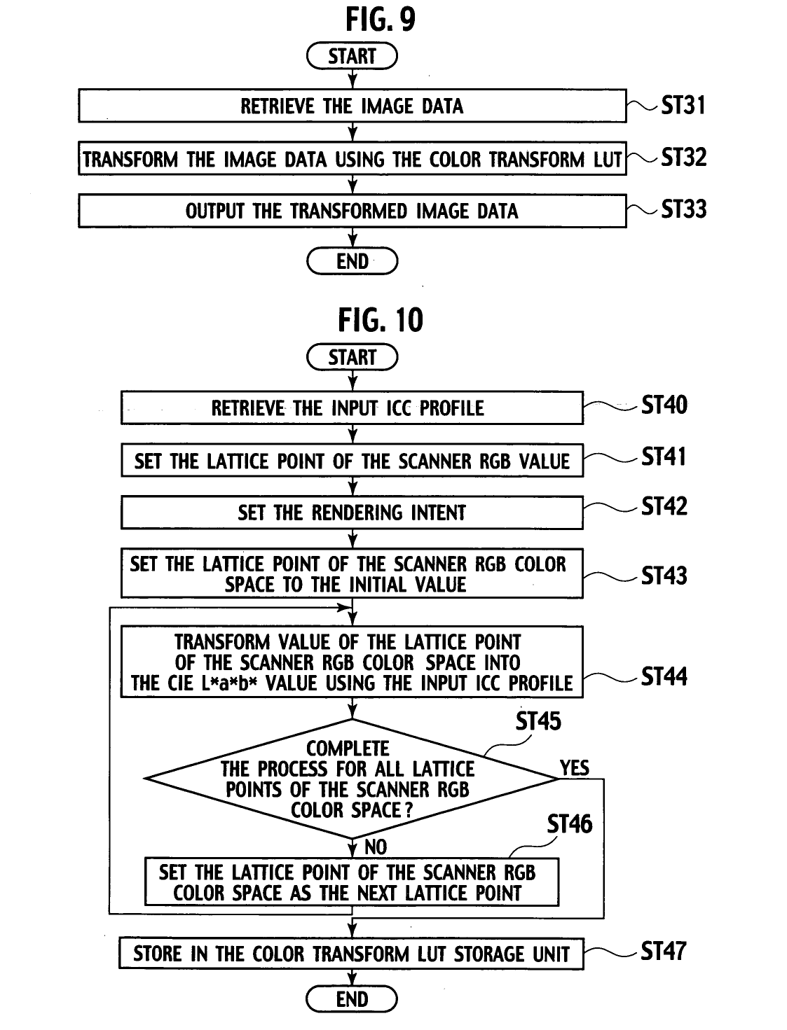

Operation of the image processing device including the above-described configuration is set forth below with reference to flowcharts shown in FIG. 7 and FIG. 9. FIG. 7 is a flowchart showing the procedure for a process (a first process) in which the color transform LUT generator 61a generates the color transform look-up table. FIG. 9 is a flowchart showing procedure for a process (a second process) in which the image data stored in the PC 9 etc., is transmitted to the output device using the generated color transform look-up table.

The color transform LUT generator 61a retrieves the Output profile of the color printer 8 stored in the ICC profile storage unit 62 and transmits the profile to the RAM 3 (step ST20).

Then, the color transform LUT generator 61a sets the lattice points of the CIE-L*a*b value in a manner similar to the first embodiment (step ST21).

The color transform LUT generator 61a displays information for setting the type of rendering intent on the display 4 by encouraging the user to select the desired rendering intent using the input device 5 (step ST22).

The color transform LUT generator 61a sets the lattice points of the CIE-Lab color space to an initial value, for example, (0, 0, 0) in step ST 23. Then, the image data of the CIE-Lab color space (device independent color space) is transformed into the image data of the printer CMYK color space, based on the Output profile retrieved to the RAM 3 (step ST24).

The above transform process in step ST24 is performed for each lattice point (pixel value) of the CIE-Lab color space (NO in step ST25 and step ST 26). After the transform process is completed (YES in step ST25), the generated color transform look-up table is stored in the color transform LUT storage unit 63 and then the process is completed.

Thus, the color transform look-up table is generated. The color transform look-up table contributes to transforming the image data in the device independent color space, such as the CIE-Lab color space, into the image data in the device dependent color space, such as the printer CMYK color space of the color printer 8.

Next, the procedure for the color printer 8 printing out a printed sheet concerning the color image data stored in a storage unit of the PC 9 etc., using the generated color transform look-up table, is described below with reference to a flowchart shown in FIG. 9.

The color image data, such as the image data in the CIE-Lab color space, stored in the PC 9 etc. is retrieved (step ST31). Herewith, the color image data is retrieved to the image processing device 1.

The color transform look-up table stored in the color transform LUT storage unit 63 is retrieved and transmitted to the RAM 3 to perform the process in which the retrieved image data is transformed into the image data of the printer CMYK of the color printer 8 (step ST32).

Then, the image data of the printer CMYK is outputted out by the color printer 8 (step ST33).

As above, in the second embodiment for example, in the case that, as an operation of a system including the image processing device 1 and scanner 7, image data of the device independent color space is stored in the device 1 preliminarily and the image data is transformed into image data of the device dependent color space, the image data in the device independent color space, such as the CIE-Lab color space, is directly transformed into the image data in the device dependent color space, such as the printer CMYK of the color printer 8, so as to decrease the amount of time for processing the image data. Also, according to the second embodiment, resources needed for the color transform are reduced because the amount of data of the color transform look-up table is reduced, if necessary.

Next, the image processing device of the third embodiment of the present invention is described below.

In the third embodiment shown in FIG. 12, the image data in the scanner RGB (device dependent color space) retrieved by the scanner 7 is transformed into the image data in the CIE-Lab color space (device independent color space) stored in the PC 9. A configuration of the image processing device is similar to that shown in FIG. 2. However, since the color printer 8 is not necessary, it is adequate for the third embodiment that the ICC profile storage unit 62 stores the Input profile of the scanner 7.

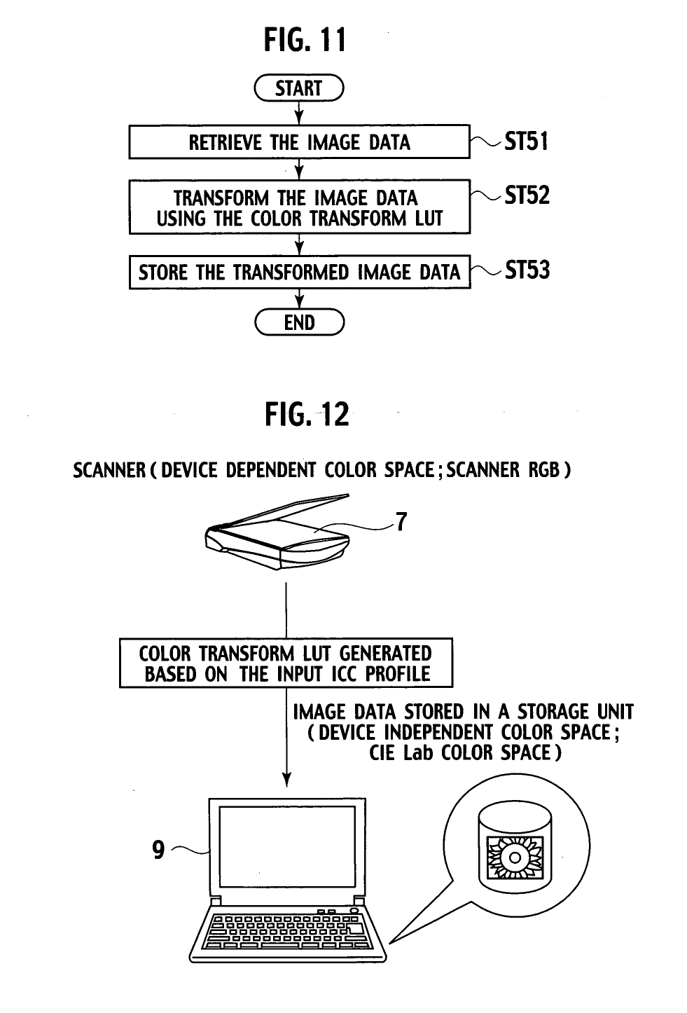

Operation of the image processing device including the above-described configuration is set forth below with reference to the flowcharts shown in FIG. 10 and FIG. 11. FIG. 10 is a flowchart showing the procedure for a process (a first process) in which the color transform LUT generator 61a generates the color transform look-up table. FIG. 11 is a flowchart showing the procedure for a process (a second process) in which the image data retrieved by the scanner 7 is transformed into the image data in the CIE-Lab color space to be stored in the storage unit of the PC 9 using the generated color transform look-up table.

The color transform LUT generator 61a retrieves the Input profile of the scanner 7 stored in the ICC profile storage unit 62 and transmits to the RAM 3 (step ST40).

Then, the color transform LUT generator 61a sets the lattice points of the scanner RGB value (step ST41) in a manner similar to the first embodiment.

The color transform LUT generator 61a displays information for setting the type of rendering intent on the display 4 by encouraging the user to select the desired rendering intent using the input device 5 (step ST42).

The color transform LUT generator 61a sets the lattice points of the scanner RGB color space to an initial value, for example, (0, 0, 0) in step ST 43. Then, the image data of the scanner RGB color space (device dependent color space) is transformed into the image data of the CIE-Lab color space (device independent color space) based on the Input profile retrieved and transmitted to the RAM 3 (step ST44).

The above transform process in step ST44 is performed for each lattice point of CIE-Lab color space (NO in step ST45 and step ST 46). After the transform process is completed (YES in step ST45), the generated color transform look-up table is stored in the color transform LUT storage unit 63 and then the process is completed.

Thus, the color transform look-up table is generated. The color transform look-up table contributes to transforming the image data in the device dependent color space, such as the scanner RGB color space of the scanner 7, into the image data in the device independent color space, such as the CIE-Lab color space.

Next, the procedure for transforming the color image data obtained by the scanner 7 into the color image data of the CIE-Lab color space, using the generated color transform look-up table to be stored in a storage unit of the PC 9 etc., is described below with reference to a flowchart shown in FIG. 11 and a diagram shown in FIG. 12.

The color image data obtained by the scanner 7, for instance, the image data of the scanner RGB of the scanner 7, is retrieved (step ST51). Herewith, the color image data is retrieved and transmitted to the image processing device 1.

The color transform look-up table stored in the color transform LUT storage unit 63 is retrieved and transmitted to the RAM 3 to perform the process in which the retrieved image data is transformed into the image data of the CIE-Lab color space (step ST52).

Then, the image data of the CIE-Lab color space is stored in the storage unit of the PC 9 etc. (step ST53).

In the third embodiment, for example, in the case that, as an operation of a system including the image processing device 1 and the printer 8, image data of the device dependent color space is retrieved by the scanner 7 and the image data is transformed into image data of the device independent color space so as to store in the device 1, the image data in the device dependent color space, such as the scanner RGB of the scanner 7, is directly transformed into the image data in the device independent color space, such as the CIE-Lab color space, so as to decrease the amount of time for processing the image data. Also, according to the third embodiment, resources needed for the color transform are reduced because the amount of data of the color transform look-up table is reduced, if necessary.

Further, according to the image processing device in the third embodiment, the image data of the scanner RGB (device dependent color space) retrieved by the scanner is transformed into the image data of the CIE-Lab color space (device independent color space) using the generated color transform look-up table. Therefore, the image processing is performed more speedily and accurately than in the prior art using the well-known

An image processing method and the image processing device are set forth above. However, the present invention is not limited to the embodiments, and the above-described components may be replaced with any components functioning similar to the above-described components.

For example, while the scanner 7 serves as the device (first device) for obtaining the image data, another device such as a digital camera and so on might be available for the present invention. Thus, the invention is not limited to the scanner 7. Similarly, while the color printer 8 serves as the device (second device) for transmitting the image data, another device is also available for the present invention. Thus, the invention is not limited to the color printer 8.

The present invention contributes to the speed-enhanced image processing among devices.

What is claimed is:

1. An image processing method for transforming image data in a device dependent color space of a first device into image data in a device dependent color space of a second device, the image processing method comprising:
generating a color transform look-up table configured to transform the image data in the device dependent color space of the first device into the image data in the device dependent color space of the second device in accordance with an ICC profile of the first device and the second device;
transforming the image data retrieved from the first device into the image data in the device dependent color space of the second device by referring to the color transform look-up table.

2. An image processing method for transforming image data in a device independent color space into image data in a device dependent color space of a given device, the image processing method comprising:
generating a color transform look-up table configured to transform the image data in the device independent color space into the image data in the device dependent color space of the given device in accordance with an ICC profile of the given device;
transforming the image data in the device independent color space into the image data in the device dependent color space of the given device by referring to the color transform look-up table.

3. An image processing method for transforming image data in a device dependent color space of a given device into image data in a device independent color space, the image processing method comprising:
generating a color transform look-up table configured to transform the image data in the device dependent color space of the given device into the image data in the device independent color space in accordance with an ICC profile of the given device;
transforming the image data retrieved from the given device into the image data in the device independent color space by referring to the color transform look-up table.

4. The image processing method according to claim 1, wherein
the device dependent color space includes at least one of a RGB color space, a CMYK color space, an HSV color space, an HSB color space, and an HLS color space.

5. The image processing method according to claim 2, wherein
the device independent color space includes at least one of a CIE-XYZ color space, a CIE-Lab color space, and an sRGB color space.

6. The image processing method according to claim 1, further comprising:
preparing a plurality of types of rendering intent, each of the types being selectable, wherein
the color transform look-up table is generated in accordance with the type of rendering intent.

7. The image processing method according to claim 1, further comprising:
changing the data size of the color transform look-up table by changing the number of lattice points in color space associated with the color transform look-up table.

8. An image processing device for transforming image data in a device dependent color space of a first device into image data in a device dependent color space of a second device, the image processing device comprising:
a storage unit configured to store ICC profiles of the first device and the second device;
a color transform look-up table generator configured to generate a color transform look-up table transforming the image data in the device dependent color space of the first device into the image data in the device dependent color space of the second device in accordance with the ICC profiles of the first device and the second device; and
a color transform look-up table storage unit configured to store the color transform look-up table, which is used in the case that a process of transforming the image data in the device dependent color space of the first device into image data in the device dependent color space of the second device, is performed.

9. An image processing device for transforming image data in a device independent color space into image data in a device dependent color space of a given device, the image processing device comprising:
a storage unit configured to store ICC profiles of the given device;
a color transform look-up table generator configured to generate a color transform look-up table transforming the image data in the device independent color space into the image data in the device dependent color space of the given device in accordance with the ICC profiles of the given device; and
a color transform look-up table storage unit configured to store the color transform look-up table, which is used in the case that a process of transforming the image data in the device independent color space into the image data in the device dependent color space of the given device, is performed.

10. An image processing device for transforming image data in a device dependent color space of a given device into image data in a device independent color space, the image processing device comprising:
a storage unit configured to store ICC profiles of the given device;
a color transform look-up table generator configured to generate a color transform look-up table transforming the image data in the device dependent color space of the given device into the image data in the device independent color space in accordance with the ICC profiles of the given device; and
a color transform look-up table storage unit configured to store the color transform look-up table, which is used in the case that a process of transforming the image data in the device dependent color space of the given device into the image data in the device independent color space, is performed.
